(19) United States
(12) Patent Application Publication
(10) Pub. No.: US 2026/0267742 A1
(43) Pub. Date: Sep. 10, 2026

(54) CONTROL METHOD AND APPARATUS FOR BASEBOARD CONTROL UNIT, AND ELECTRONIC DEVICE AND NON-VOLATILE READABLE STORAGE MEDIUM

(71) Applicant: SUZHOU METABRAIN INTELLIGENT TECHNOLOGY CO., LTD., Suzhou, Jiangsu (CN)

(72) Inventors: Wenkai MA, Suzhou, Jiangsu (CN); Baoyang LIU, Suzhou, Jiangsu (CN); Ming SUN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/876,159

(22) PCT Filed: Sep. 27, 2023
(86) PCT No.: PCT/CN2023/121854

§ 371 Date: Dec. 17, 2024

(30) Foreign Application Priority Data
Jan. 18, 2023 (CN) 202310067089.2

(51) Int. Cl. G06F 11/14

(52) U.S. Cl. CPC G06F 11/1438

(57) ABSTRACT

A control method and apparatus for a baseboard control unit, and an electronic device and a non-volatile readable storage medium are provided. The method includes: obtaining current system information of the baseboard control unit when the baseboard control unit runs to a preset status; storing the system information; and restoring the baseboard control unit based on the system information after a kernel panic occurs in an operating system of the baseboard control unit. Restoring is implemented after the kernel panic occurs in the operating system of the BMC, the robustness of the BMC system is increased, and then the stability of the entire server is strengthened.

### CROSS-REFERENCE TO RELATED APPLICATION

The present application is a National Stage Application of PCT International Application No.: PCT/CN2023/121854 filed on Sep. 27, 2023, which claims priority to Chinese Patent Application 202310067089.2, filed in the China National Intellectual Property Administration on Jan. 18, 2023, the disclosure of which is incorporated herein by reference in its entirety.

### TECHNICAL FIELD

This application relates to the computer technology field and relates to a control method and apparatus for a baseboard control unit, and an electronic device and a non-volatile readable storage medium.

### BACKGROUND

A Baseboard Manager Controller (BMC), baseboard manager controller is a baseboard control unit configured to manage server hardware and has a complete and independent operating system. An entire working environment for the BMC does not need to rely on a hardware resource or software resource of an Operating System (OS), operating system of a server. When the server is powered on, even when the OS is not started, the BMC begins to monitor statuses of some hardware resources in the server and process and report any abnormal status when any. Therefore, whether the BMC in the server may work normally has become a great factor in determining whether the server may work normally for a long time. Therefore, to improve the robustness of the server itself, the robustness of the software/hardware of the BMC needs to be improved. However, the BMC may also cause a kernel panic (kernel panic) in a Linux system in the BMC due to some internal or external factors, which leads to a lack of monitoring of the server within a phase.

No effective solution has been proposed to resolve the above problem in related technologies.

### SUMMARY

This application is intended to provide a control method and apparatus for a baseboard control unit, and an electronic device and a non-volatile readable storage medium, so that restoring is implemented after a kernel panic occurs in an operating system of the BMC.

According to a first aspect, this application provides a control method for a baseboard control unit, including:
obtaining current system information of the baseboard control unit when the baseboard control unit runs to a preset status;
storing the system information; and
restoring the baseboard control unit based on the system information after a kernel panic occurs in an operating system of the baseboard control unit.

The obtaining current system information of the baseboard control unit when the baseboard control unit runs to a preset status includes:
obtaining the current system information of the baseboard control unit when the operating system of the baseboard control unit is started.

The obtaining current system information of the baseboard control unit when the baseboard control unit runs to a preset status includes:
obtaining the current system information of the baseboard control unit when the baseboard control unit runs to a time node for shell login.

The obtaining current system information of the baseboard control unit when the baseboard control unit runs to a preset status includes:
obtaining the current system information of the baseboard control unit at preset time intervals after the baseboard control unit runs to a shell login status.

The method further includes:
obtaining the preset time intervals from a device tree.

Before the obtaining current system information of the baseboard control unit when the baseboard control unit runs to a preset status, the method further includes:
reading a base address and size of a synchronous dynamic random access memory and a base address and size of a system information storage area from a device tree; and
determining, based on the base address of the synchronous dynamic random access memory and the base address of the system information storage area, a storage size provided to the operating system.

The storing the system information includes:
storing the system information in the system information storage area.

The storing the system information includes:
storing the system information in a JavaScript Object Notation (JSON) format.

The system information includes a combination of any one or more of register data of a central processing unit, register data of peripheral, and page table data.

The register data of a central processing unit includes a value and length of each register in the central processing unit, the register data of the peripheral includes a value and length of each register in the peripheral, and the page table data includes a value and length of each page table entry in a page table.

The obtaining current system information of the baseboard control unit includes:
obtaining the length of each register in the central processing unit, the length of each register in the peripheral, and/or the length of each page table entry in the page table from a device tree.

Before the obtaining current system information of the baseboard control unit when the baseboard control unit runs to a preset status, the method further includes:
reading a base address and size of a synchronous dynamic random access memory, a base address and size of a register data storage area of the central processing unit, a base address and size of a register data storage area of the peripheral, and a base address and size of a page table data storage area from a device tree; and
determining, based on the base address of the synchronous dynamic random access memory and the base address of the register data storage area of the central processing unit, a storage size provided to an operating system.

The storing the system information includes:
storing the register data of the central processing unit in a register data storage area of the central processing unit,
and/or storing the register data of the peripheral in a register data storage area of the peripheral,
and/or storing the page table data in a page table data store.

When the system information includes the register data of the central processing unit, the register data of the peripheral, and the page table data, the restoring the baseboard control unit based on the system information includes:
obtaining current register data of the peripheral;
determining whether the current register data of the peripheral is consistent with stored register data of the peripheral; and
in a case that the current register data of the peripheral is consistent with the stored register data of the peripheral, restoring the stored register data of the central processing unit and stored page table data to corresponding positions.

The obtaining current system information of the baseboard control unit when the baseboard control unit runs to a preset status includes:
obtaining the current system information of the baseboard control unit when the operating system of the baseboard control unit is started;
obtaining the current system information of the baseboard control unit when the baseboard control unit runs to a time node for shell login; and
obtaining the current system information of the baseboard control unit at preset time intervals after the baseboard control unit runs to a shell login status.

The register data of a central processing unit includes a first storage area, a second storage area, and a third storage area. The first storage area is used to store current register data of the central processing unit when the operating system of the baseboard control unit is started, the second storage area is used to store current register data of the central processing unit when the baseboard control unit runs to the time node for shell login, and the third storage area is used to store current register data of the central processing unit at preset time intervals after the baseboard control unit runs to the shell login status.

The register data storage area of the peripheral includes a fourth storage area, a fifth storage area, and a sixth storage area. The fourth storage area is used to store current register data of the peripheral when the operating system of the baseboard control unit is started, the fifth storage area is used to store current register data of the peripheral when the baseboard control unit runs to the time node for shell login, and the sixth storage area is used to store current register data of the peripheral at preset time intervals after the baseboard control unit runs to the shell login status.

The page table data storage area includes a seventh storage area, an eighth storage area, and a ninth storage area. The seventh storage area is used to store current page table data when the operating system of the baseboard control unit is started, the eighth storage area is used to store current page table data when the baseboard control unit runs to the time node for shell login, and the ninth storage area is used to store current page table data at preset time intervals after the baseboard control unit runs to the shell login status.

When the system information includes the register data of the central processing unit, the register data of the peripheral, and the page table data, the restoring the baseboard control unit based on the system information includes:
S1: obtaining current register data of the peripheral;
S2: determining whether the current register data of the peripheral is consistent with register data of the peripheral stored in the sixth storage area; and in a case that the current register data of the peripheral is consistent with the register data of the peripheral stored in the sixth storage area, going to S3; or in a case that the current register data of the peripheral is not consistent with the register data of the peripheral stored in the sixth storage area, going to S4;
S3: restoring the register data of the central processing unit stored in the third storage area and the page table data stored in the ninth storage area to corresponding positions;
S4: determining whether the current register data of the peripheral is consistent with register data of the peripheral stored in the fifth storage area; and in a case that the current register data of the peripheral is consistent with the register data of the peripheral stored in the fifth storage area, going to S5; or in a case that the current register data of the peripheral is not consistent with the register data of the peripheral stored in the fifth storage area, going to S6.
S5: restoring the register data of the central processing unit stored in the second storage area and the page table data stored in the eighth storage area to corresponding positions;
S6: determining whether the current register data of the peripheral is consistent with register data of the peripheral stored in the fourth storage area; and in a case that the current register data of the peripheral is consistent with the register data of the peripheral stored in the fourth storage area, going to S7; or in a case that the current register data of the peripheral is not consistent with the register data of the peripheral stored in the fourth storage area, going to S8.
S7: restoring the register data of the central processing unit stored in the first storage area and the page table data stored in the seventh storage area to corresponding positions; and
S8: restarting the operating system.

According to a second aspect, this application provides a control apparatus for a baseboard control unit, including:
a first obtaining module, configured to obtain current system information of the baseboard control unit when the baseboard control unit runs to a preset status;
a storage module, configured to store the system information; and
a restoring module, configured to restore the baseboard control unit based on the system information after a kernel panic occurs in an operating system of the baseboard control unit.

According to a third aspect, this application provides an electronic device, including:
a memory, configured to store a computer program; and
a processor, configured to execute the following operations:
obtaining current system information of the baseboard control unit when the baseboard control unit runs to a preset status;
storing the system information; and
restoring the baseboard control unit based on the system information after a kernel panic occurs in an operating system of the baseboard control unit.

According to a fourth aspect, this application provides a non-volatile readable storage medium, wherein the non-volatile readable storage medium stores a computer program, the computer program, when being executed on a processor, causes the processor to execute operations comprising:
obtaining current system information of the baseboard control unit when the baseboard control unit runs to a preset status;
storing the system information; and
restoring the baseboard control unit based on the system information after a kernel panic occurs in an operating system of the baseboard control unit.

According to a first aspect, this application provides a control method for a baseboard control unit, including:
obtaining the current system information of the baseboard control unit when the operating system of the baseboard control unit enters a start point.

It may be learned from the above solutions that a control method for a baseboard control unit provided in this application includes: obtaining current system information of the baseboard control unit when the baseboard control unit runs to a preset status; storing the system information; and restoring the baseboard control unit based on the system information after a kernel panic occurs in an operating system of the baseboard control unit.

In the control method for a baseboard control unit provided in this application, when the baseboard control unit runs to the preset status, the current system information is recorded. After the kernel panic occurs in the operating system of the baseboard control unit, restoring may be performed based on the stored system information. It may be learned that, in the control method for a baseboard control unit provided in this application, restoring is implemented after the kernel panic occurs in the operating system of the BMC, the robustness of the BMC system is increased, and then the stability of the entire server is strengthened. This application further discloses a control apparatus for a baseboard control unit, and an electronic device and a non-volatile readable storage medium, so that the above technical effect may be achieved.

It should be understood that the above general description and the following detailed description are merely examples, and may not limit this application.

### BRIEF DESCRIPTION OF THE DRAWINGS

To describe the solutions in embodiments of this application or in the conventional technology more clearly, the following briefly describes the accompanying drawings for describing embodiments or the conventional technology. It is clear that the accompanying drawings in the following descriptions show merely some embodiments of this application, and a person of ordinary skill in the art may still derive other drawings from these accompanying drawings without creative efforts. The accompanying drawings are intended to understand the present disclosure, form a part of the specification, and are used to explain the present disclosure in combination with the following optional implementations, without limiting the present disclosure. In the accompanying drawings,

FIG. 1 is a flowchart of a control method for a baseboard control unit according to an exemplary embodiment;

FIG. 2 is a flowchart of another control method for a baseboard control unit according to an exemplary embodiment;

FIG. 3 is a flowchart of a control method for a baseboard control unit according to an application embodiment of this application;

FIG. 4 is a schematic diagram of storage space according to an application embodiment of this application;

FIG. 5 is a flowchart of a restoring method for an operating system of a BMC according to an application embodiment of this application;

FIG. 6 is a structural diagram of a control apparatus for a baseboard control unit according to an exemplary embodiment; and

FIG. 7 is a structural diagram of an electronic device according to an exemplary embodiment.

### DETAILED DESCRIPTION OF THE EMBODIMENTS

The following clearly and completely describes technical solutions in embodiments of this application with reference to accompanying drawings in embodiments of this application. Apparently, described embodiments are merely some but not all of the embodiments of this application. Based on the embodiments of this application, all other embodiments obtained by a person of ordinary skill in the art without creative efforts fall within the protection scope of this application. In addition, in the embodiments of this application, “first”, “second”, and the like are intended to distinguish between similar objects, but do not necessarily indicate a optional order or sequence.

An embodiment of this application discloses a controlling method for a baseboard control unit, implementing restoring after a kernel panic occurs in an operating system of a BMC.

Refer to FIG. 1. A flowchart of a control method for a baseboard control unit is shown according to an exemplary embodiment, as shown in FIG. 1, including the following steps.

S101: Obtain current system information of the baseboard control unit when the baseboard control unit runs to a preset status.

In an optional implementation, the current system information is obtained when the baseboard control unit runs to the preset status. The system information includes a combination of any one or more of register data of a central processing unit (cpu_reg), register data of peripheral (peripheral_reg), and page table data (page_table). The register data of a central processing unit includes a value and length of each register in the central processing unit, the register data of peripheral includes a value and length of each register in the peripheral, and the page table data includes a value and length of each page table entry in a page table. Each of the above lengths may be obtained from a device tree. Optionally, the obtaining current system information of the baseboard control unit includes: obtaining the length of each register in the central processing unit, the length of each register in the peripheral, and/or the length of each page table entry in a page table from the device tree.

In a feasible implementation, the obtaining current system information of the baseboard control unit when the baseboard control unit runs to a preset status includes: obtaining the current system information of the baseboard control unit when an operating system of the baseboard control unit is started. In the optional implementation, the current system information may be recorded when a kernel of the operating system of the BMC enters a start point.

In another feasible implementation, the obtaining current system information of the baseboard control unit when the baseboard control unit runs to a preset status includes: obtaining the current system information of the baseboard control unit when the baseboard control unit runs to a time node for shell (shell) login. The current system information may be recorded after the operating system runs to the time node for shell login.

In still another feasible implementation, the obtaining current system information of the baseboard control unit when the baseboard control unit runs to a preset status includes: obtaining the current system information of the baseboard control unit at preset time intervals after the operating system runs to a shell login status. In an optional implementation, the current system information is recorded at preset time intervals after the operating system runs to the shell login status. The preset time intervals may be flexibly set by using the device tree and is not limited herein. Optionally, this embodiment further includes: obtaining the preset time intervals from the device tree.

In an optional implementation, before the obtaining current system information of the baseboard control unit when the baseboard control unit runs to a preset status, the method further includes: reading a base address and size of a synchronous dynamic random access memory and a base address and size of a system information storage area from a device tree; and determining, based on the base address of the synchronous dynamic random access memory and the base address of the system information storage area, a storage size provided to the operating system.

In an optional implementation, after a server is powered on, during a uboot (bootloader) phase, the BMC starts reading the base address and size of the synchronous dynamic random access memory a Synchronous Dynamic Random Access Memory (SDRAM) and the base address and size of the system information storage area in a uboot device tree file. A storage size provided to the operating system is a value obtained by making the base address of the system information storage area minus the base address of the synchronous dynamic random access memory.

S102: Store the system information.

In an optional implementation, the current system information is stored. In a feasible implementation, the storing the system information includes: storing the system information in the system information storage area. In an optional implementation, the register data of a central processing unit is stored in a register data storage area of the central processing unit, the register data of peripheral is stored in a register data storage area of the peripheral, and the page table data is stored in a page table data storage area.

In a feasible implementation, the register data of a central processing unit includes a first storage area, a second storage area, and a third storage area. The first storage area is used to store current register data of the central processing unit when the operating system of the baseboard control unit is started, the second storage area is used to store current register data of the central processing unit when the baseboard control unit runs to the time node for shell login, and the third storage area is used to store current register data of the central processing unit at preset time intervals after the baseboard control unit runs to the shell login status. The register data storage area of the peripheral includes a fourth storage area, a fifth storage area, and a sixth storage area. The fourth storage area is used to store current register data of the peripheral when the operating system of the baseboard control unit is started, the fifth storage area is used to store current register data of the peripheral when the baseboard control unit runs to the time node for shell login, and the sixth storage area is used to store current register data of the peripheral at preset time intervals after the baseboard control unit runs to the shell login status. The page table data storage area includes a seventh storage area, an eighth storage area, and a ninth storage area. The seventh storage area is used to store current page table data when the operating system of the baseboard control unit is started, the eighth storage area is used to store current page table data when the baseboard control unit runs to the time node for shell login, and the ninth storage area is used to store current page table data at preset time intervals after the baseboard control unit runs to the shell login status.

It should be noted that the obtained system information may be organized in JSON format. In other words, the storing system information includes: storing the system information in JSON format. Various types of system information are organized as follows:

```

[symbol]

    “cpu_reg” :[

[symbol]

[symbol]

        “R0” : “value” , “length” : “x1” [symbol] , [symbol]
        “R1” : “value” , “length” : “x2” [symbol] ,
          ...

[symbol]

[symbol]


“peripherals_reg” :[

[symbol]

[symbol]

        “0x1 [symbol] 690000” : “value” , “length” : “y1” [symbol] , [symbol]
        “0x1 [symbol] 6 [symbol] 0000” : “value” , “length” : “y2” [symbol] ,
            ...

[symbol]

[symbol]


  “page_table” :[

[symbol]

[symbol]

        “0x80007000” : “value” , “length” : “z1” [symbol] , [symbol]
        “0x8000700 [symbol] ” : “value” , “length” : “z2” [symbol] ,
            ...

[symbol]

[symbol]

[symbol]

[symbol]



indicates data missing or illegible when filed
```

where R0 and R1 are registers of the central processing unit, value is a value of the register, length is a length field, x1 is a length of a value of a register R0, x2 is a length of a value of a register R1, 0x1e690000 and 0x1e6e0000 are registers of the peripheral, value is a value of the register, length is a length field, y1 is a length of a value of the register 0x1e690000, y2 is a length of a value of the register 0x1e6e0000, 0x80007000 and 0x80007004 are addresses of page table entries, value is a value of the page table entry, length is a length field, z1 is a length of a value stored in the address 0x80007000, and z2 is a length of a value stored in the address 0x80007004.

S103: Restore the baseboard control unit based on the system information after a kernel panic occurs in the operating system of the baseboard control unit.

In an optional implementation, after the kernel panic occurs in the operating system of the baseboard control unit, the baseboard control unit is restored based on the stored system information, to restore the baseboard control unit to a time node corresponding to the preset status.

In a feasible implementation, the restoring the baseboard control unit based on the system information includes: obtaining the current register data of the peripheral; determining whether the current register data of the peripheral is consistent with stored register data of the peripheral; and in a case that the current register data of the peripheral is consistent with the stored register data of the peripheral, restoring the stored register data of the central processing unit and stored page table data to corresponding positions. In an optional implementation, after the kernel panic occurs in the operating system of the baseboard control unit, the current register data of the peripheral is obtained, and it is determined whether the current register data of the peripheral is consistent with the stored register data of the peripheral. In a case that the current register data of the peripheral is consistent with the stored register data of the peripheral, the stored register data of the central processing unit and stored page table data are restored to corresponding positions. In a case that the current register data of the peripheral is not consistent with the stored register data of the peripheral, the operating system is directly restarted.

In the control method for a baseboard control unit provided in the embodiment of this application, when the baseboard control unit runs to the preset status, the current system information is recorded. After the kernel panic occurs in the operating system of the baseboard control unit, restoring may be performed based on the stored system information. It may be learned that, in the control method for a baseboard control unit provided in the embodiment of this application, restoring is implemented after the kernel panic occurs in the operating system of the BMC, the robustness of the BMC system is increased, and then the stability of the entire server is strengthened.

An embodiment of this application discloses a control method for a baseboard control unit, and technical solutions are described and optimized compared with the previous embodiment. Optionally,

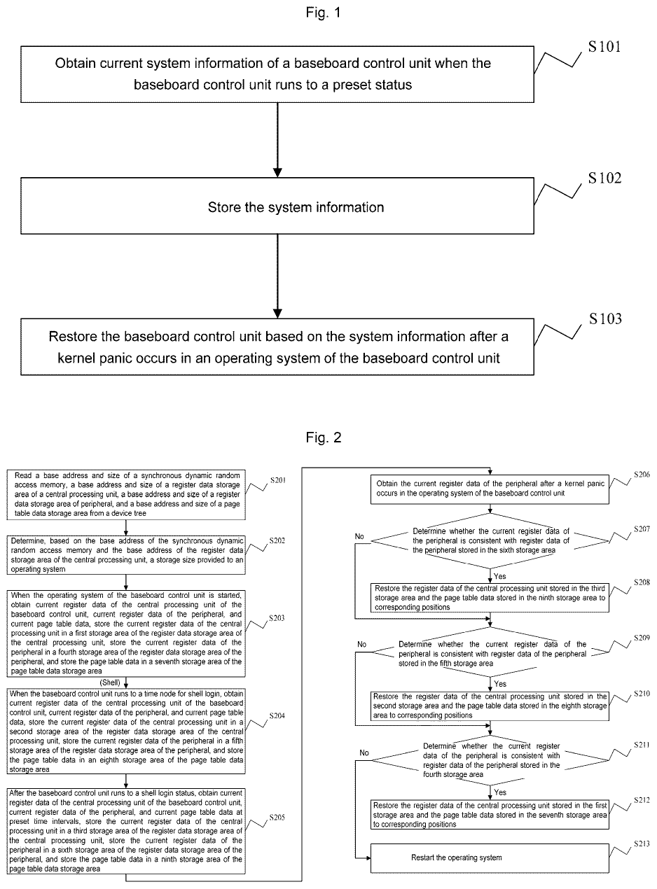

FIG. 2 shows a flowchart of another control method for a baseboard control unit according to an exemplary embodiment. As shown in FIG. 2, the method includes the following steps.

S201: Read a base address and size of a synchronous dynamic random access memory, a base address and size of a register data storage area of a central processing unit, a base address and size of a register data storage area of peripheral, and a base address and size of a page table data storage area from a device tree.

S202: Determine, based on the base address of the synchronous dynamic random access memory and the base address of the register data storage area of the central processing unit, a storage size provided to an operating system.

In an optional implementation, after a server is powered on, in a uboot phase, the BMC starts to read a base address and a size of SDRAM in a uboot device tree file as A and B respectively, a base address and size of cpu_reg as C and D respectively, a base address and size of peripheral_reg as E and F respectively, and a base address and size of page_table as G and H respectively, and a storage size handed over to a subsequent operating system is user_mem=C−A.

S203: When the operating system of the baseboard control unit is started, obtain current register data of the central processing unit of the baseboard control unit, current register data of the peripheral, and current page table data, store the current register data of the central processing unit in a first storage area of the register data storage area of the central processing unit, store the current register data of the peripheral in a fourth storage area of the register data storage area of the peripheral, and store the page table data in a seventh storage area of the page table data storage area.

In an optional implementation, when a kernel of the operating system of the BMC enters a start point, current cpu_reg, peripheral_reg, and page_table data are recorded, classified, compressed, and stored in corresponding storage areas.

S204: When the baseboard control unit runs to a time node for shell login, obtain current register data of the central processing unit of the baseboard control unit, current register data of the peripheral, and current page table data, store the current register data of the central processing unit in a second storage area of the register data storage area of the central processing unit, store the current register data of the peripheral in a fifth storage area of the register data storage area of the peripheral, and store the page table data in an eighth storage area of the page table data storage area.

In an optional implementation, after the operating system runs to the time node for shell login, current cpu_reg, peripheral_reg, and page_table data are recorded, classified, compressed, and stored in corresponding storage areas.

S205: After the baseboard control unit runs to a shell login status, obtain current register data of the central processing unit of the baseboard control unit, current register data of the peripheral, and current page table data at preset time intervals, store the current register data of the central processing unit in a third storage area of the register data storage area of the central processing unit, store the current register data of the peripheral in a sixth storage area of the register data storage area of the peripheral, and store the page table data in a ninth storage area of the page table data storage area.

In an optional implementation, after the baseboard control unit runs to the shell login status, current cpu_reg, peripheral_reg, and page_table data are recorded, classified, compressed, and stored in corresponding storage areas at preset time intervals.

S206: Obtain the current register data of the peripheral after a kernel panic occurs in the operating system of the baseboard control unit.

S207: Determine whether the current register data of the peripheral is consistent with register data of the peripheral stored in the sixth storage area; and in a case that the current register data of the peripheral is consistent with the register data of the peripheral stored in the sixth storage area, go to S208; or in a case that the current register data of the peripheral is not consistent with the register data of the peripheral stored in the sixth storage area, go to S209.

S208: Restore the register data of the central processing unit stored in the third storage area and the page table data stored in the ninth storage area to corresponding positions.

S209: Determine whether the current register data of the peripheral is consistent with register data of the peripheral stored in the fifth storage area; and in a case that the current register data of the peripheral is consistent with the register data of the peripheral stored in the fifth storage area, go to S210; or in a case that the current register data of the peripheral is not consistent with the register data of the peripheral stored in the fifth storage area, go to S211.

S210: Restore the register data of the central processing unit stored in the second storage area and the page table data stored in the eighth storage area to corresponding positions.

S211: Determine whether the current register data of the peripheral is consistent with register data of the peripheral stored in the fourth storage area; and in a case that the current register data of the peripheral is consistent with the register data of the peripheral stored in the fourth storage area, go to S212; or in a case that the current register data of the peripheral is not consistent with the register data of the peripheral stored in the fourth storage area, go to S213.

S212: Restore the register data of the central processing unit stored in the first storage area and the page table data stored in the seventh storage area to corresponding positions.

S213: Restart the operating system.

In an optional implementation, when the kernel panic occurs during BMC running, all peripheral_reg data is decompressed, and the peripheral_reg data when the kernel panic occurs is compared with the peripheral_reg data stored in the sixth storage area to determine whether the data is consistent. When the data is consistent, cpu_reg data stored in the third storage area and page_table stored in the ninth storage area are restored to corresponding positions, so that the operating system of the BMC jumps to a corresponding time node and continues running. When the data is not consistent, the peripheral_reg data when the kernel panic occurs is continuously compared with peripheral_reg data stored in the fifth storage area to determine whether the data is consistent. When the data is consistent, cpu_reg data stored in the second storage area and page_table stored in the eighth storage area are restored to corresponding positions, so that the operating system of the BMC jumps to the time node for shell login and continues running. When the data is not consistent, the peripheral_reg data when the kernel panic occurs is continuously compared with peripheral_reg data stored in the fourth storage area to determine whether the data is consistent. When the data is consistent, cpu_reg data stored in the first storage area and page_table stored in the seventh storage area are restored to corresponding positions, so that the operating system of the BMC jumps to a start time node and continues running. When the data is not consistent, the entire operating system is directly restarted.

It may be learned that this embodiment provides a self-restoring method for a BMC system after the kernel panic occurs, resolving the following problem: when the kernel panic occurs in the BMC system, a table may be matched based on a currently set fault type and restoring node, and a corresponding time node may be dynamically selected for restoring based on the current fault type, increasing the robustness of the BMC system, and further strengthening the stability of the entire server.

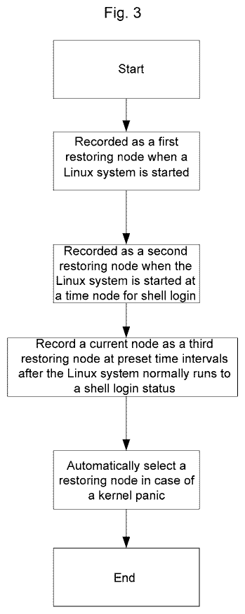

A consistent application embodiment provided in this application is described below, and a flowchart of the control method for a baseboard control unit in an application embodiment provided in this application is shown in FIG. 3, including the following steps.

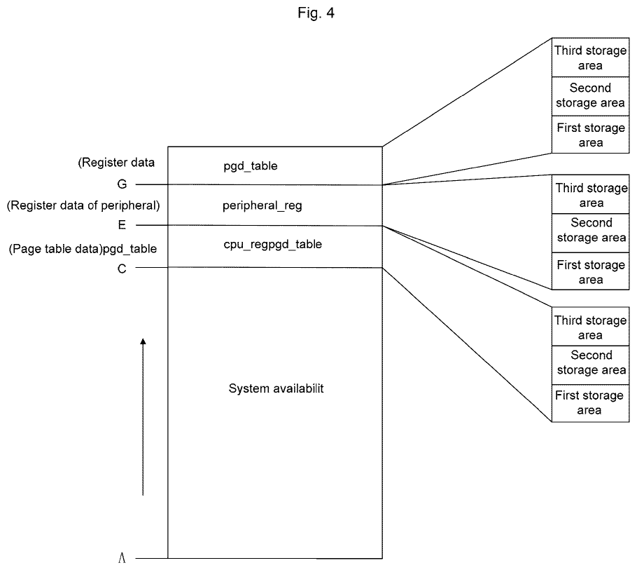

Step 1: After a server is powered on, in a uboot phase, a BMC starts to read a base address and a size of SDRAM in a uboot device tree file as A and B respectively, a base address and size of cpu_reg as C and D respectively, a base address and size of peripheral_reg as E and F respectively, and a base address and size of page_table as G and H respectively, and a storage size handed over to a subsequent operating system is user_mem=C−A, as shown in FIG. 4.

Step 2: Recording three restoring points for restoring after the kernel panic occurs, including the following steps:

2.1: when a kernel of a Linux of the BMC enters a start point, recording and organizing in JSON format current cpu_reg, peripheral_reg, and page_table data, and then classifying, compressing, and storing the data in corresponding first storage areas in FIG. 4;

2.2: after the Linux system runs to a time node for shell login, recording and organizing in JSON format current cpu_reg, peripheral_reg, and page_table data, and then classifying, compressing, and storing the data in corresponding second storage areas in FIG. 4; and

2.3: In a subsequent operation process, recording and organizing in JSON format current cpu_reg, peripheral_reg, and page_table data once at the Optional time intervals (flexibly set by a time device tree), and then classifying, compressing, and storing the data in corresponding third storage areas in FIG. 4.

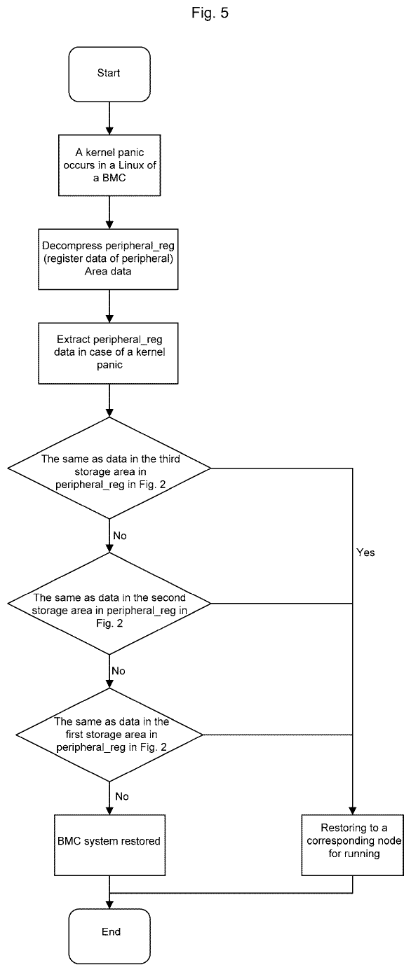

Step 3: When a kernel panic occurs during BMC running, first decompressing all data corresponding to the peripheral_reg areas in FIG. 4, and then extracting peripheral_reg data when the kernel panic occurs, as shown in FIG. 5, including the following steps:

3.1: comparing the peripheral_reg data when the kernel panic occurs with data in a third storage area corresponding to peripheral_reg in FIG. 4, when the data is the same, decompressing data in a third storage area corresponding to cpu_reg in FIG. 4 and data in a third storage area corresponding to page_table, and then restoring the data to current corresponding positions in the Linux systems, so that the current system jumps to a node corresponding to the third storage area for running;

3.2: when the data is different through matching, matching data in a second storage area corresponding to peripheral_reg in FIG. 4; when the data is still different, matching data in a first storage area corresponding to peripheral_reg in FIG. 4; and when the data is yet different, directly restarting the entire Linux system.

The following is an introduction to a control apparatus for a baseboard control unit provided in an embodiment of this application, and the control apparatus for a baseboard control unit described below may be cross-referenced with the control method for a baseboard control unit described above.

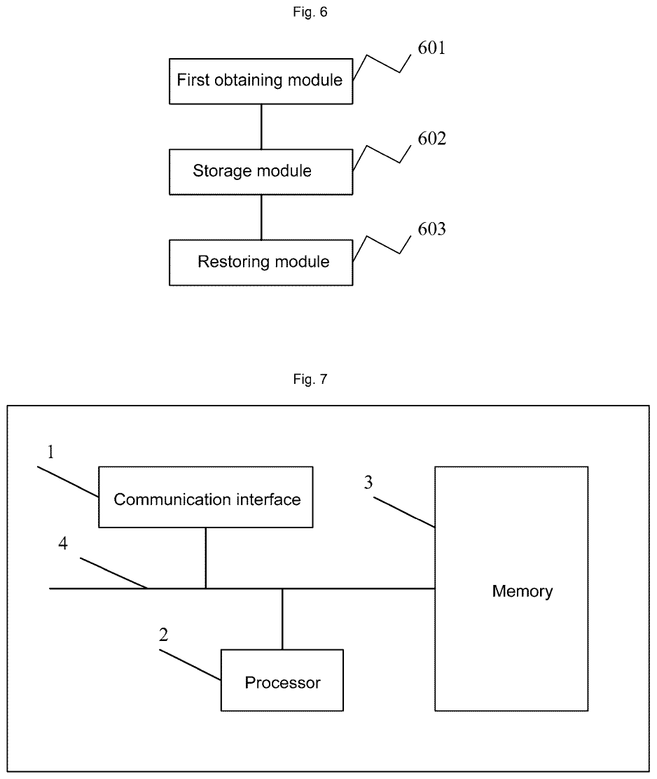

Refer to FIG. 6. A structural diagram of a control apparatus for a baseboard control unit is provided according to an exemplary embodiment, as shown in FIG. 6, including the following modules:
a first obtaining module 601, configured to obtain current system information of the baseboard control unit when the baseboard control unit runs to a preset status;
a storage module 602, configured to store the system information; and
a restoring module 603, configured to restore the baseboard control unit based on the system information after a kernel panic occurs in an operating system of the baseboard control unit.

In the control apparatus for a baseboard control unit provided in the embodiment of this application, when the baseboard control unit runs to the preset status, the current system information is recorded. After the kernel panic occurs in the operating system of the baseboard control unit, restoring may be performed based on the stored system information. It may be learned that, in the control apparatus for a baseboard control unit provided in the embodiment of this application, restoring is implemented after the kernel panic occurs in the operating system of the BMC, the robustness of the BMC system is increased, and then the stability of the entire server is strengthened.

Based on the above embodiment, in an optional implementation, the first obtaining module 601 is configured to obtain current system information of the baseboard control unit when the operating system of the baseboard control unit is started.

Based on the above embodiment, in an optional implementation, the first obtaining module 601 is configured to obtain current system information of the baseboard control unit when the baseboard control unit runs to a time node for shell login.

Based on the above embodiment, in an optional implementation, the first obtaining module 601 is configured to obtain the current system information of the baseboard control unit at preset time intervals after the baseboard control unit runs to a shell login status.

Based on the above embodiment, in an optional implementation, the apparatus further includes:
a second obtaining module, configured to obtain the preset time intervals from a device tree.

Based on the above embodiment, in an optional implementation, the apparatus further includes:
a first reading module, configured to read a base address and size of a synchronous dynamic random access memory and a base address and size of a system information storage area from the device tree; and
a first determining module, configured to determine, based on the base address of the synchronous dynamic random access memory and the base address of the system information storage area, a storage size provided to the operating system.

Based on the above embodiment, in an optional implementation, the storage module 602 is configured to store the system information in a system information storage area.

Based on the above embodiment, in an optional implementation, the storage module 602 is configured to store the system information in JSON format.

Based on the above embodiment, in an optional implementation, the system information includes a combination of any one or more of register data of a central processing unit, register data of peripheral, and page table data.

Based on the above embodiment, in an optional implementation, the register data of a central processing unit includes a value and length of each register in the central processing unit, the register data of peripheral includes a value and length of each register in the peripheral, and the page table data includes a value and length of each page table entry in a page table.

Based on the above embodiment, in an optional implementation, the first obtaining module 601 is configured to obtain the length of each register in the central processing unit, the length of each register in the peripheral, and/or the length of each page table entry in the page table from the device tree.

Based on the above embodiment, in an optional implementation, the apparatus further includes:
a second reading module, configured to read a base address and size of a synchronous dynamic random access memory, a base address and size of a register data storage area of a central processing unit, a base address and size of a register data storage area of peripheral, and a base address and size of a page table data storage area from the device tree; and
a second determining module, configured to determine, based on the base address of the synchronous dynamic random access memory and the base address of the register data storage area of the central processing unit, a storage size provided to an operating system.

Based on the above embodiment, in an optional implementation, the storage module 602 is configured to: store the register data of a central processing unit in a register data storage area of the central processing unit, store the register data of peripheral in a register data storage area of the peripheral, and/or store the page table data in a page table data storage area.

Based on the above embodiment, in an optional implementation, when the system information includes register data of a central processing unit, register data of peripheral, and page table data, the restoring module 603 is configured to: obtain the current register data of the peripheral after a kernel panic occurs in the operating system of the baseboard control unit; determine whether the current register data of the peripheral is consistent with stored register data of the peripheral; and in a case that the current register data of the peripheral is consistent with the stored register data of the peripheral, restore the stored register data of the central processing unit and stored page table data to corresponding positions.

Based on the above embodiment, in an optional implementation, the first obtaining module 601 is configured to: obtain the current system information of the baseboard control unit when the operating system of the baseboard control unit is started; obtain the current system information of the baseboard control unit when the baseboard control unit runs to a time node for shell login; and obtain the current system information of the baseboard control unit at preset time intervals after the baseboard control unit runs to a shell login status.

Based on the above embodiment, in an optional implementation, the register data of a central processing unit includes a first storage area, a second storage area, and a third storage area. The first storage area is used to store current register data of the central processing unit when the operating system of the baseboard control unit is started, the second storage area is used to store current register data of the central processing unit when the baseboard control unit runs to the time node for shell login, and the third storage area is used to store current register data of the central processing unit at preset time intervals after the baseboard control unit runs to the shell login status. The register data storage area of the peripheral includes a fourth storage area, a fifth storage area, and a sixth storage area. The fourth storage area is used to store current register data of the peripheral when the operating system of the baseboard control unit is started, the fifth storage area is used to store current register data of the peripheral when the baseboard control unit runs to the time node for shell login, and the sixth storage area is used to store current register data of the peripheral at preset time intervals after the baseboard control unit runs to the shell login status. The page table data storage area includes a seventh storage area, an eighth storage area, and a ninth storage area. The seventh storage area is used to store current page table data when the operating system of the baseboard control unit is started, the eighth storage area is used to store current page table data when the baseboard control unit runs to the time node for shell login, and the ninth storage area is used to store current page table data at preset time intervals after the baseboard control unit runs to the shell login status.

Based on the above embodiment, in an optional implementation, when the system information includes register data of a central processing unit, register data of peripheral, and page table data, the restoring module 603 is configured to: after the kernel panic occurs in the operating system of the baseboard control unit, obtain the current register data of the peripheral; determine whether the current register data of the peripheral is consistent with the register data of the peripheral stored in the sixth storage area; in a case that the current register data of the peripheral is consistent with the register data of the peripheral stored in the sixth storage area, restore the register data of the central processing unit stored in the third storage area and page table data stored in the ninth storage area to corresponding positions; in a case that the current register data of the peripheral is not consistent with the register data of the peripheral stored in the sixth storage area, determine whether the current register data of the peripheral is consistent with register data of the peripheral stored in the fifth storage area; in a case that the current register data of the peripheral is consistent with the register data of the peripheral stored in the fifth storage area, restore the register data of the central processing unit stored in the second storage area and page table data stored in the eighth storage area to corresponding positions; in a case that the current register data of the peripheral is not consistent with the register data of the peripheral stored in the fifth storage area, determine whether the current register data of the peripheral is consistent with register data of the peripheral stored in the fourth storage area; in a case that the current register data of the peripheral is consistent with the register data of the peripheral stored in the fourth storage area, restore the register data of the central processing unit stored in the first storage area and page table data stored in the seventh storage area to corresponding positions; and In a case that the current register data of the peripheral is not consistent with the register data of the peripheral stored in the fourth storage area, restart the operating system.

For the apparatus in the above embodiment, manners for performing operations by each module are described in detail in embodiments related to the method, and details are not described herein.

Based on hardware implementation of the above program module, and to implement the method in the embodiment of this application, an embodiment of this application further provides an electronic device. FIG. 7 is a structural diagram of the electronic device according to an exemplary embodiment. As shown in FIG. 7, the electronic device includes:
a communication interface 1, capable of performing information exchange with other devices such as a network device; and
a processor 2, connected to the communication interface 1 to implement information exchange with other devices, and configured to perform the control method for a baseboard control unit provided in the above one or more technical solutions when a computer program is run. The computer program is stored on a memory 3.

Of course, in actual application, all components in the electronic device are coupled together via a bus system 4. It may be understood that the bus system 4 is configured to implement connection and communication between these components. In addition to a data bus, the bus system 4 further includes a power bus, a control bus, and a status signal bus. However, for clarity of description, various buses are marked as the bus system 4 in FIG. 7.

The memory 3 in the embodiment of this application is configured to store various types of data to support operation of the electronic device. An example of the data includes: any computer program operated on the electronic device.

It may be understood that the memory 3 may be a volatile memory or a non-volatile memory, or may include both a volatile memory and a non-volatile memory. The non-volatile memory may be a read only memory a Read Only Memory (ROM), a programmable read-only memory a Programmable Read-Only Memory (PROM), an erasable programmable read-only memory a Erasable Programmable Read-Only Memory (EPROM), an electrically erasable programmable read-only memory a Electrically Erasable Programmable Read-Only Memory (EEPROM), a ferromagnetic random access memory a Ferromagnetic Random Access Memory (FRAM), a Flash Memory, a magnetic surface memory, an optical disc, or a compact disc read-only memory a Compact Disc Read-Only Memory (CD-ROM). The magnetic surface memory may be either a disc memory or tape memory. The volatile memory may be a random access memory a Random Access Memory (RAM), and is used as an external cache. By using an example description but not a restrictive description, RAMs in many forms may be used, for example, a static random access memory a Static Random Access Memory (SRAM), a synchronous static random access memory a Synchronous Static Random Access Memory (SSRAM), a dynamic random access memory a Dynamic Random Access Memory (DRAM), a synchronous dynamic random access memory a Synchronous Dynamic Random Access Memory (SDRAM), a double data rate synchronous dynamic random access memory a Double Data Rate Synchronous Dynamic Random Access Memory (DDRSDRAM), an enhanced synchronous dynamic random access memory a Enhanced Synchronous Dynamic Random Access Memory (ESDRAM), a synchlink dynamic random access memory a SyncLink Dynamic Random Access Memory (SLDRAM), and a direct rambus random access memory a Direct Rambus Random Access Memory (DRRAM). The memory 3 described in the embodiment of this application is intended to include but is not limited to these and any other suitable types of memories.

The method disclosed in the above embodiments of this application may be applied to the processor 2, or may be implemented by the processor 2. The processor 2 may be an integrated circuit device having a signal processing capability. During implementation, each step of the above method may be completed by using an integrated logic circuit of hardware in the processor 2 or an instruction in a form of software. The processor 2 may further be a general-purpose processor, a DSP, or another programmable logic device, a discrete gate or transistor logic device, a discrete hardware component, or the like. The processor 2 may implement or perform the method, the steps, and the logical block diagrams disclosed in embodiments of this application. The general-purpose processor may be a microprocessor or any conventional processor or the like. Steps of the methods disclosed with reference to embodiments of this application may be directly executed and completed by a hardware decoding processor, or may be executed and completed by using a combination of hardware and software modules in the decoding processor. The software module may be located in the non-volatile readable storage medium. The non-volatile readable storage medium is located in the memory 3, the memory 2 reads programs in the memory 3, and steps in the above method are completed in combination with the hardware.

For the sake of brevity, corresponding flows in various methods for implementing the embodiments of this application when the processor 2 executes the program are not repeated herein.

In an exemplary embodiment, an embodiment of this application further provides a non-volatile readable storage medium, which is a computer non-volatile readable storage medium, including, for example, the memory 3 that stores a computer program, and the computer program may be executed by the processor 2 to complete the previous method steps. The non-volatile readable storage medium may be a memory such as a FRAM, ROM, PROM, EPROM, EEPROM, Flash Memory, magnetic surface memory, an optical disc, or a CD-ROM.

A person skilled in the art may understand that all or some of steps for implementing the embodiments of the above methods may be completed by hardware related to the program instructions, and the program may be stored in a non-volatile readable storage medium. When the program is executed, steps including the embodiments of the methods are performed. The above non-volatile readable storage media includes various non-volatile readable storage media that may store program code, such as a removable storage device, a ROM, a RAM, a magnetic disk, or an optical disc.

Alternatively, when the above integrated unit of this application is implemented in the form of a software functional module and sold or used as an independent product, the integrated unit may be stored in a non-volatile readable storage medium. Based on such understanding, the technical solutions or a part that contributes to the prior art of the embodiments of this application may be essentially embodied in the form of a software product, the software product is stored in a non-volatile readable storage medium, including several instructions for enabling an electronic device (which may be a personal computer, server, network equipment, or the like) to perform all or a part of the method of each embodiment of this application. The above non-volatile readable storage media includes various non-volatile readable storage media that may store program code, such as a removable storage device, a ROM, a RAM, a magnetic disk, or an optical disc.

The above descriptions are merely optional implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A control method for a baseboard control unit, comprising:
obtaining current system information of the baseboard control unit when the baseboard control unit runs to a preset status;
storing the system information; and
restoring the baseboard control unit based on the system information after a kernel panic occurs in an operating system of the baseboard control unit.

2. The control method for a baseboard control unit according to claim 1, wherein the obtaining current system information of the baseboard control unit when the baseboard control unit runs to a preset status comprises:
obtaining the current system information of the baseboard control unit when the operating system of the baseboard control unit is started.

3. The control method for a baseboard control unit according to claim 1, wherein the obtaining current system information of the baseboard control unit when the baseboard control unit runs to a preset status comprises:
obtaining the current system information of the baseboard control unit when the baseboard control unit runs to a time node for shell login.

4. The control method for a baseboard control unit according to claim 1, wherein the obtaining current system information of the baseboard control unit when the baseboard control unit runs to a preset status comprises:
obtaining the current system information of the baseboard control unit at preset time intervals after the baseboard control unit runs to a shell login status.

5. The control method for a baseboard control unit according to claim 4, wherein the method further comprises:
obtaining the preset time intervals from a device tree.

6. The control method for a baseboard control unit according to claim 1, wherein before the obtaining current system information of the baseboard control unit when the baseboard control unit runs to a preset status, the method further comprises:
reading a base address and size of a synchronous dynamic random access memory and a base address and size of a system information storage area from a device tree; and
determining, based on the base address of the synchronous dynamic random access memory and the base address of the system information storage area, a storage size provided to the operating system.

7. The control method for a baseboard control unit according to claim 6, wherein the storing the system information comprises:
storing the system information in the system information storage area.

8. The control method for a baseboard control unit according to claim 1, wherein the storing the system information comprises:
storing the system information in a JavaScript Object Notation (JSON) format.

9. The control method for a baseboard control unit according to claim 1, wherein the system information comprises a combination of any one or more of register data of a central processing unit, register data of peripheral, and page table data.

10. The control method for a baseboard control unit according to claim 9, wherein the register data of the central processing unit comprises a value and length of each register in the central processing unit, the register data of the peripheral comprises a value and length of each register in the peripheral, and the page table data comprises a value and length of each page table entry in a page table.

11. The control method for a baseboard control unit according to claim 10, wherein the obtaining current system information of the baseboard control unit comprises:
obtaining the length of each register in the central processing unit, the length of each register in the peripheral, and/or the length of each page table entry in the page table from a device tree.

12. The control method for a baseboard control unit according to claim 9, wherein before the obtaining current system information of the baseboard control unit when the baseboard control unit runs to a preset status, the method further comprises:
reading a base address and size of a synchronous dynamic random access memory, a base address and size of a register data storage area of the central processing unit, a base address and size of a register data storage area of the peripheral, and a base address and size of a page table data storage area from a device tree; and
determining, based on the base address of the synchronous dynamic random access memory and the base address of the register data storage area of the central processing unit, a storage size provided to the operating system.

13. The control method for a baseboard control unit according to claim 9, wherein the storing the system information comprises:
storing the register data of the central processing unit in a register data storage area of the central processing unit,
and/or storing the register data of the peripheral in a register data storage area of the peripheral,
and/or storing the page table data in a page table data store.

14. The control method for a baseboard control unit according to claim 13, wherein when the system information comprises the register data of the central processing unit, the register data of the peripheral, and the page table data, the restoring the baseboard control unit based on the system information comprises:
obtaining current register data of the peripheral;
determining whether the current register data of the peripheral is consistent with stored register data of the peripheral; and
in a case that the current register data of the peripheral is consistent with the stored register data of the peripheral, restoring the stored register data of the central processing unit and stored page table data to corresponding positions.

15. The control method for a baseboard control unit according to claim 13, wherein the obtaining current system information of the baseboard control unit when the baseboard control unit runs to a preset status comprises:
obtaining the current system information of the baseboard control unit when the operating system of the baseboard control unit is started;
obtaining the current system information of the baseboard control unit when the baseboard control unit runs to a time node for shell login; and
obtaining the current system information of the baseboard control unit at preset time intervals after the baseboard control unit runs to a shell login status.

16. The control method for a baseboard control unit according to claim 15, wherein the register data storage area of the central processing unit comprises a first storage area, a second storage area, and a third storage area, the first storage area is used to store current register data of the central processing unit when the operating system of the baseboard control unit is started, the second storage area is used to store current register data of the central processing unit when the baseboard control unit runs to the time node for shell login, and the third storage area is used to store current register data of the central processing unit at preset time intervals after the baseboard control unit runs to the shell login status;
the register data storage area of the peripheral comprises a fourth storage area, a fifth storage area, and a sixth storage area, the fourth storage area is used to store current register data of the peripheral when the operating system of the baseboard control unit is started, the fifth storage area is used to store current register data of the peripheral when the baseboard control unit runs to the time node for shell login, and the sixth storage area is used to store current register data of the peripheral at preset time intervals after the baseboard control unit runs to the shell login status; and
the page table data storage area comprises a seventh storage area, an eighth storage area, and a ninth storage area, the seventh storage area is used to store current page table data when the operating system of the baseboard control unit is started, the eighth storage area is used to store current page table data when the baseboard control unit runs to the time node for shell login, and the ninth storage area is used to store current page table data at preset time intervals after the baseboard control unit runs to the shell login status.

17. The control method for a baseboard control unit according to claim 16, wherein when the system information comprises the register data of the central processing unit, the register data of the peripheral, and the page table data, the restoring the baseboard control unit based on the system information comprises:
S1: obtaining current register data of the peripheral;
S2: determining whether the current register data of the peripheral is consistent with register data of the peripheral stored in the sixth storage area; and in a case that the current register data of the peripheral is consistent with the register data of the peripheral stored in the sixth storage area, going to S3; or in a case that the current register data of the peripheral is not consistent with the register data of the peripheral stored in the sixth storage area, going to S4;
S3: restoring the register data of the central processing unit stored in the third storage area and the page table data stored in the ninth storage area to corresponding positions;
S4: determining whether the current register data of the peripheral is consistent with register data of the peripheral stored in the fifth storage area; and in a case that the current register data of the peripheral is consistent with the register data of the peripheral stored in the fifth storage area, going to S5; or in a case that the current register data of the peripheral is not consistent with the register data of the peripheral stored in the fifth storage area, going to S6;
S5: restoring the register data of the central processing unit stored in the second storage area and the page table data stored in the eighth storage area to corresponding positions;
S6: determining whether the current register data of the peripheral is consistent with register data of the peripheral stored in the fourth storage area; and in a case that the current register data of the peripheral is consistent with the register data of the peripheral stored in the fourth storage area, going to S7; or in a case that the current register data of the peripheral is not consistent with the register data of the peripheral stored in the fourth storage area, going to S8;
S7: restoring the register data of the central processing unit stored in the first storage area and the page table data stored in the seventh storage area to corresponding positions; and
S8: restarting the operating system.

18. (canceled)

19. An electronic device, comprising:
a memory, configured to store a computer program; and
a processor, configured to execute the following operations:
obtaining current system information of the baseboard control unit when the baseboard control unit runs to a preset status;
storing the system information; and
restoring the baseboard control unit based on the system information after a kernel panic occurs in an operating system of the baseboard control unit.

20. A non-volatile readable storage medium, wherein the non-volatile readable storage medium stores a computer program, the computer program, when being executed on a processor, causes the processor to execute operations comprising:
obtaining current system information of the baseboard control unit when the baseboard control unit runs to a preset status;
storing the system information; and
restoring the baseboard control unit based on the system information after a kernel panic occurs in an operating system of the baseboard control unit.

21. The control method for a baseboard control unit according to claim 1, wherein the obtaining current system information of the baseboard control unit when the baseboard control unit runs to a preset status comprises:
obtaining the current system information of the baseboard control unit when the operating system of the baseboard control unit enters a start point.
